(19) United States
(12) Patent Application Publication
(10) Pub. No.: US 2026/0094024 A1
(43) Pub. Date: Apr. 2, 2026

(54) MANAGING INFERENCE MODEL RESISTANCE TO POISONED TRAINING DATA

(71) Applicant: Dell Products L.P., Round Rock, TX (US)

(72) Inventors: OFIR EZRIELEV, Be'er Sheva (IL); JEHUDA SHEMER, Kfar Saba (IL); ONUR CELEBIOGLU, Austin, TX (US)

(21) Appl. No.: 18/899,164

(22) Filed: Sep. 27, 2024

(51) Int. Cl. G06N 5/04

(52) U.S. Cl. CPC G06N 5/04

(57) ABSTRACT

Methods and systems for providing computer-implemented services using inference models are disclosed. To provide the computer-implemented services, it may be identified that at least a portion of training data used to train an inference model is poisoned training data. A first training procedure and a second training procedure may be performed. A first testing procedure may be performed to determine whether the inference model meets performance criteria. If the inference model meets the performance criteria, it may be concluded that the inference model is untrained on the poisoned training data and trained on the known good training data. The inference model may be used to provide the computer-implemented services. If the inference model does not meet the performance criteria, a retraining procedure may be performed.

### FIELD

Embodiments disclosed herein relate generally to managing inference models. More particularly, embodiments disclosed herein relate to systems and methods to manage inference model resistance to poisoned training data.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2E show diagrams illustrating data flows in accordance with an embodiment.

FIG. 2F shows a diagram illustrating a neural network in accordance with an embodiment.

FIGS. 3A-3C show flow diagrams illustrating a method for providing computer-implemented services using inference models in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for providing computer-implemented services using inference models. An inference model may be a generative artificial intelligence (AI) model (e.g., a large language model (LLM)) and may be trained to generate responses when provided with prompts. The responses may be used, at least in part, to provide the computer-implemented services.

Over time, the inference model may be updated through training using training data. However, if poisoned training data (e.g., training data which includes relationships established by a malicious entity) is introduced to the inference model, the inference model may become untrustworthy (e.g., the inference model may be tainted by the poisoned training data). Responses generated using the inference model may therefore also be untrustworthy and/or inaccurate (e.g., the inference model may generate responses using an information content of the poisoned training data).

Once it has been discovered that an inference model has been tainted with poisoned training data, the inference model may require re-training to remove the influence of the poisoned training data, and any or all responses generated using the tainted inference model may be untrustworthy. Training an inference model may be a computationally expensive process and may require the use of a limited amount of computing resources that may otherwise be used for response generation. Thus, computing resources spent re-training inference models may interrupt response consumption and/or other types of computer-implemented services that may otherwise be provided using the computing resources dedicated to re-training.

Once the inference model is retrained, any and/or all responses provided to consumers using the tainted inference model may require replacement. Response generation may be required for an entire ingest dataset, prompting another inefficient use of computing resources.

To reduce computing resources spent re-training inference models, two untraining procedures may be performed for an inference model upon identifying that at least a portion of training data used to train the inference model is poisoned training data. The first untraining procedure may reduce an ability of the inference model to generate responses using an information content of the poisoned training data. Performing the first untraining procedure may include modifying weights of an architecture of the inference model until responses generated by the inference model are not based on the information content. The second untraining procedure may reduce a likelihood that the inference model generates the responses using the information content of the poisoned training data at a future point in time. Performing the second untraining procedure may include further modifying the weights of the architecture of the inference model so that the further modified weights are resistant to snap back to a state prior to the performing of the first untraining procedure (e.g., upon a second exposure to the poisoned training data).

Upon completion of the two untraining procedures, a first testing procedure may be performed to determine whether the inference model meets performance criteria. The performance criteria may define a level of ability of the inference model to provide desirable responses to a first set of prompts based on the poisoned training data and a second set of prompts based on known good training data (e.g., training data which is not poisoned). The inference model may provide the desirable responses when the inference model provides inconsistent responses to the first set of prompts based on the poisoned training data and consistent and accurate responses to the second set of prompts based on the known good training data. Providing the desirable responses may indicate the inference model is not trained on the poisoned training data and is trained on the known good training data. The inference model may then be used to provide the computer-implemented services.

Thus, embodiments disclosed herein may address, among other technical problems, the technical challenge of preventing future poisoning of an inference model with poisoned training data. By performing two untraining procedures, the inference model may be less likely to become poisoned upon a second exposure to the poisoned training data, thereby reducing a resource expenditure to re-train and/or replace the inference model. Consequently, a likelihood of providing computer-implemented services to downstream consumers as desired may be increased.

In an embodiment, a method for providing computer-implemented services using inference models is disclosed. The method may include: identifying that at least a portion of training data used to train an inference model is poisoned training data; performing a first untraining procedure to reduce an ability of the inference model to generate responses using an information content of the poisoned training data; performing a second untraining procedure to reduce a likelihood that the inference model generates the responses using the information content of the poisoned training data at a future point in time; performing a first testing procedure to determine whether the inference model meets performance criteria, the performance criteria defining a level of ability of the inference model to provide desirable responses to at least a second set of prompts based on known good training data; in a first instance of the performing in which the inference model meets the performance criteria: concluding that the inference model is untrained on the poisoned training data and trained on the known good training data; using the inference model to provide the computer-implemented services; and in a second instance of the performing in which the inference model does not meet the performing criteria: performing a retraining procedure to improve a likelihood that the inference model meets the performance criteria.

Performing the first untraining procedure may include: modifying weights of an architecture of the inference model until responses generated by the inference model are not based on the information content.

Performing the second untraining procedure may include: further modifying the weights of the architecture of the inference model so that the further modified weights are resistant to snap back to a state prior to the performing of the first untraining procedure.

The poisoned training data may include relationships established by a malicious entity.

The inference model may provide the desirable responses when the inference model provides inconsistent responses to a first set of prompts based on the poisoned training data and consistent and accurate responses to the second set of prompts based on the known good training data.

The inference model providing the inconsistent responses to the first set of prompts may indicate that the inference model is not trained on the poisoned training data, and the inference model providing the consistent and accurate responses to the second set of prompts may indicate that the inference model is trained on the known good training data.

Performing the first testing procedure may include: performing a first attempting to verify that the inference model provides inconsistent responses to a first set of prompts based on the poisoned training data; in a first instance of the first attempting where the inference model provides the inconsistent responses to the first set of prompts: performing a second attempting to verify that the inference model provides consistent responses to the second set of prompts; in a first instance of the second attempting where the inference model provides the consistent responses to the second set of prompts: performing a third attempting to verify that the inference model provides accurate responses to the second set of prompts.

Performing the first attempting may include: obtaining, using the first set of prompts, a set of responses from the inference model, the set of responses including: a first response to a first prompt of the first set of prompts, and a second response to a second prompt of the first set of prompts; performing a response agreement testing process to obtain a level of agreement between at least the first response and the second response; making a determination regarding whether the level of agreement meets criteria; in a first instance of the determination in which the level of agreement meets the criteria: concluding that the inference model does not provide the inconsistent responses to the first set of prompts; and in a second instance of the determination in which the level of agreement does not meet the criteria: concluding that the inference model provides the inconsistent responses to the first set of prompts.

Performing the third attempting may include: comparing a first information content of the consistent responses to the second set of prompts to a second information content of the known good training data to obtain a level of similarity between the first information content and the second information content; making a determination regarding whether the level of similarity meets a level of similarity threshold; in a first instance of the determination in which the level of similarity meets the level of similarity threshold: concluding that the inference model provides the accurate responses to the second set of prompts; and in a second instance of the determination in which the level of similarity does not meet the level of similarity threshold: concluding that the inference model does not provide the accurate responses to the second set of prompts.

The inference model may be a generative artificial intelligence (AI) model.

In an embodiment, a non-transitory media is provided that may include instructions that when executed by a processor cause the computer-implemented method to be performed.

In an embodiment, a data processing system is provided that may include the non-transitory media and a processor, and may perform the computer-implemented method when the computer instructions are executed by the processor.

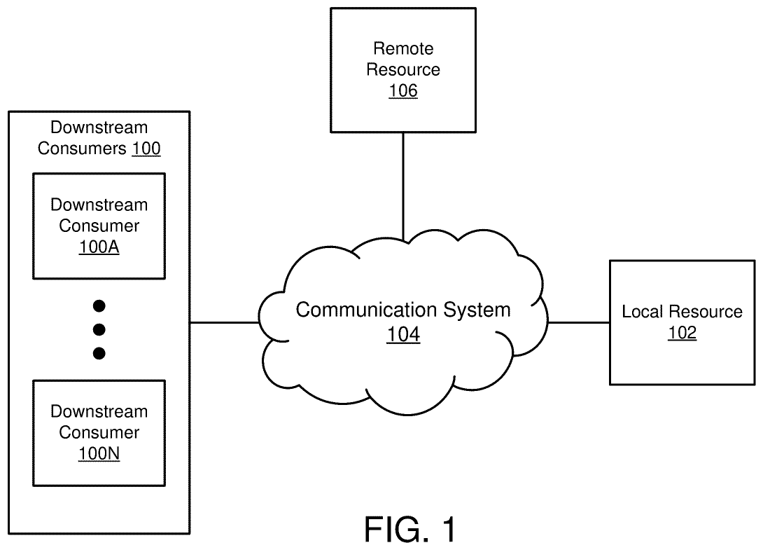

Turning to FIG. 1, a block diagram illustrating a system in accordance with an embodiment is shown. The system shown in FIG. 1 may provide computer-implemented services. The computer-implemented services may include any type and quantity of computer-implemented services. For example, the computer-implemented services may include data storage services, instant messaging services, database services, data generation services, and/or any other type of service that may be implemented with a computing device. The computer-implemented services may be provided, at least in part, using inference models and/or inferences (e.g., responses) obtained using the inference models.

To provide the computer-implemented services, the inference models may be trained, operated, and/or otherwise controlled (e.g., hosted) by a remote resource (e.g., a third-party entity) and/or by a local resource. The local resource may be owned by a first owner and the remote resource may be owned by a second owner. In addition, the first owner may or may not control the remote resource. For example, an inference model used in the provision of the computer-implemented services may be hosted by the remote resource and may provide responses to the local resource. The responses may be provided to downstream consumers as computer-implemented services and/or may be utilized to facilitate the computer-implemented services.

To obtain the responses used to provide the computer-implemented services, the inference models may be trained, using training data, to generate the responses when provided with prompts (e.g., ingest data). The inference models may include generative artificial intelligence (AI) inference models (e.g., large language models (LLMs)); therefore, the responses may include new instances of data created by the generative AI inference models based on learned associations from and/or an understanding of the training data. For example, the inference models may be trained using unstructured data, such as stories, essays, audio transcription, video description, and/or other types of human interpretable text, to generate responses of the same.

Training an inference model and/or obtaining responses from the inference model may consume computing resources of the entity which hosts the inference model (e.g., the remote resource). The remote resource may have access to a finite number of computing resources (e.g., processors, memory modules, storage devices, etc.), and/or may determine at any point in time which computing resources should be allocated to training an instance of the inference model, using the inference model to generate responses, and/or any other task related to managing the inference model.

The remote resource may provide the responses generated by the inference model to the local resource, which may use the responses while providing the computer-implemented services to the downstream consumers. However, if the responses from the inference model are unavailable, then the local resource may be unable to provide, at least in part, the computer-implemented services, may provide less desirable computer-implemented services, and/or may otherwise be impacted in an undesirable manner. For example, if the local resource is providing computer-implemented services using responses relied upon by the downstream consumers, then the downstream consumers may be deprived of the responses and/or computer-implemented services when the limited computing resources of the remote resource are allocated to training an inference model instance rather than obtaining responses.

Over time, new versions of the inference model may be obtained by the remote resource. The new versions of the inference model may be obtained, for example, due to requests from the local resource and/or the downstream consumers, acquisition of additional training data that may improve an accuracy of responses generated by the inference models, and/or for other reasons.

Training of inference models may be computationally costly because training may require significant resource expenditures. To obtain the new versions of the inference model, an existing inference model may be used as a basis for the new versions inference model, thereby leveraging the existing resource expenditures used to obtain the existing inference model. For example, new versions of the inference model may be obtained through training as more training data is obtained (e.g., incremental learning).

However, the training data used to obtain the new versions of the inference model may include poisoned training data. The poisoned training data may be manipulated by a malicious entity to elicit skewed, biased, and/or otherwise harmful responses from the new versions of the inference models. Training of the new versions of the inference model using the poisoned training data may, in turn, poison the new versions of the inference model, any responses obtained from the poisoned new versions of the inference model, and further poison other inference model instances derived from the poisoned new versions of the inference model.

In general, embodiments disclosed herein may provide methods, systems, and/or devices for managing an inference model trained using poisoned training data in a manner which reduces a likelihood of the inference model becoming poisoned again in the future while preserving an ability of the inference model to generate responses usable to provide computer-implemented services. To do so, a first untraining procedure may be performed to reduce an ability of the inference model to generate responses using an information content of the poisoned training data. Performing the first training procedure may include modifying weights of an architecture of the inference model until responses generated by the inference model are not based on the information content. Upon completion of the first untraining procedure, a second untraining procedure may be performed to reduce a likelihood that the inference model generates the responses using the information content of the poisoned training data at a future point in time. Performing the second untraining procedure may include further modifying the weights of the architecture of the inference model so that the further modified weights are resistant to snap back to a state prior to the performing of the first untraining procedure.

A testing procedure may be performed to determine whether the inference model meets performance criteria using a trusted inference model. The performance criteria may define a level of ability of the inference model to provide desirable responses to a first set of prompts based on the poisoned training data and a second set of prompts based on known good training data. The inference model may provide the desirable responses when the inference model provides inconsistent responses to the first set of prompts and consistent and accurate responses to the second set of prompts. Providing the desirable responses may indicate that the inference model is untrained on the poisoned training data and trained on the known good training data.

By doing so, embodiments disclosed herein may improve inference model resistance to poisoned training data so that responses generated by inference models may have an increased likelihood of being trustworthy for use in providing computer-implemented services to downstream consumers. By performing a second untraining procedure to further modify weights of an architecture of an inference model, the modified weights may be resistant to snap back to a state prior to the performing of a first untraining procedure (e.g., upon a second exposure to the poisoned training data). Thus, a resource expenditure to train a replacement inference model upon poisoning of the inference model and/or untraining the inference model upon the second exposure to the poisoned training data may be reduced.

To provide the above noted functionality, the system of FIG. 1 may include downstream consumers 100, local resource 102, remote resource 106, and communication system 104. Each of these components is discussed below.

Downstream consumers 100 may provide and/or consume all, or a portion of, the computer-implemented services. Downstream consumers 100 may include any number of downstream consumers (e.g., 100A, 100N) and may include, for example, businesses, individuals, and/or devices (e.g., data processing systems) that may obtain responses and/or other information based on the responses as part of receiving the computer-implemented services.

Downstream consumers 100 may subscribe to computer-implemented services provided, at least in part, by local resource 102 and local resource 102 may interact with any number of other entities (e.g., remote resource 106) as part of providing the computer-implemented services. For example, remote resource 106 may provide inferencing services to local resource 102 and local resource 102 may use inferences (e.g., responses) generated by inference models hosted by remote resource 106 as part of the computer-implemented services provided to downstream consumers 100. Local resource 102 may also host inference models locally which may provide the responses used by local resource 102 in the provision of the computer-implemented services.

Remote resource 106 may manage any number of inference models and may be owned by a second owner (e.g., a third-party entity). For example, remote resource 106 may train, and/or host (e.g., operate) generative AI models and may provide inferencing services to any number of other entities. However, the inference models (e.g., the generative AI models) may be updated (e.g., retrained) over time to improve a quality of the computer-implemented services (e.g., by remote resource 106, by local resource 102). To do so, remote resource 106 may perform training, untraining, and/or evaluation processes for the inference models prior to computer-implemented services being provided based on responses generated by the inference models.

Local resource 102 may include any entity that provides, at least in part, computer-implemented services to downstream consumers 100. Local resource 102 may be owned by a first owner and the first owner may not control remote resource 106, and/or local resource 102 and remote resource 106 may be controlled by a single entity. To provide its functionality, local resource 102 may: (i) train, untrain, and/or host any number of inference models, (ii) perform consistency evaluations of inference models to determine whether the inference models provide consistent responses to a set of prompts, (iii) perform accuracy evaluations of inference models to determine whether the inference models provide accurate responses to the set of prompts (e.g., indicating the inference models have a desired knowledge base), and/or (iv) perform other actions.

For example, local resource 102 may use training data to obtain an inference model, which may be a new version of an existing inference model. The inference model may be intended to have an expanded knowledge base when compared to a knowledge base of the existing inference model (e.g., a fine-tuned model), which may improve a quality of the computer-implemented services provided using responses generated by the inference model. However, the training data used to obtain the inference model may include poisoned training data, which may result in the inference model being poisoned (e.g., providing responses using an information content of the poisoned training data).

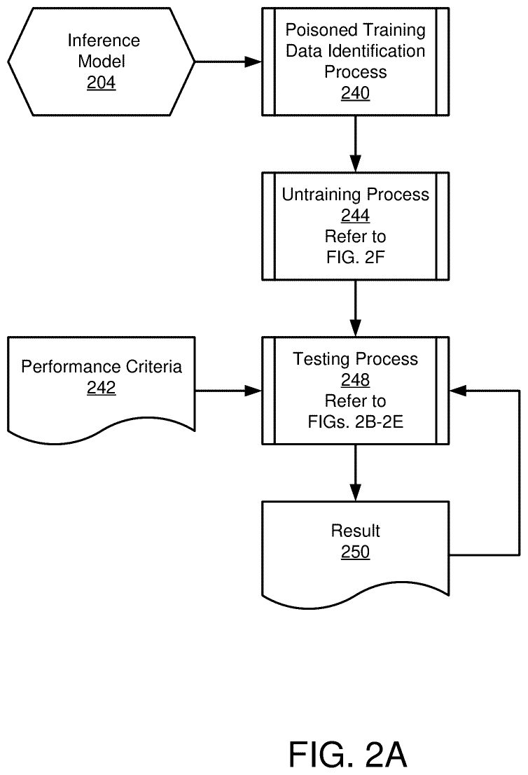

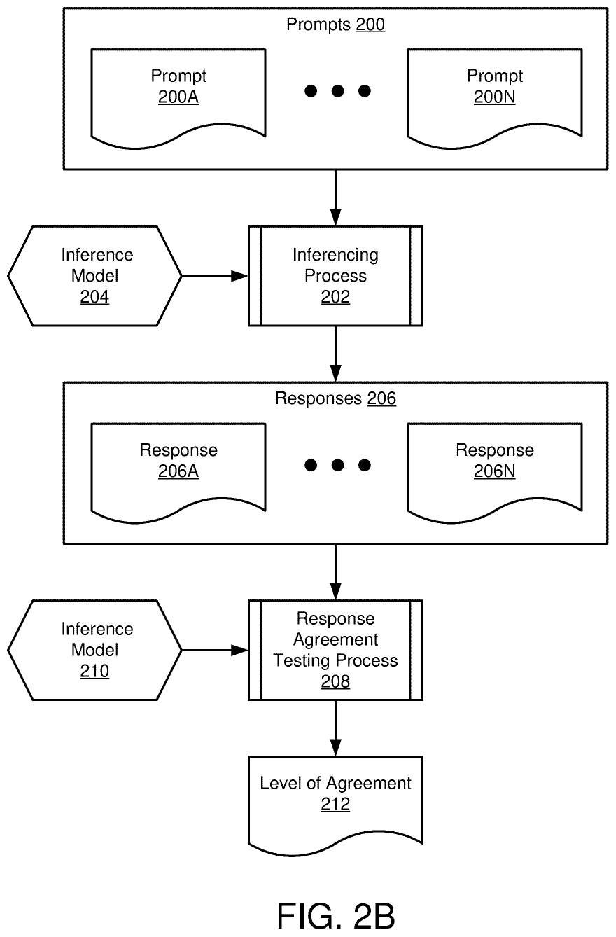

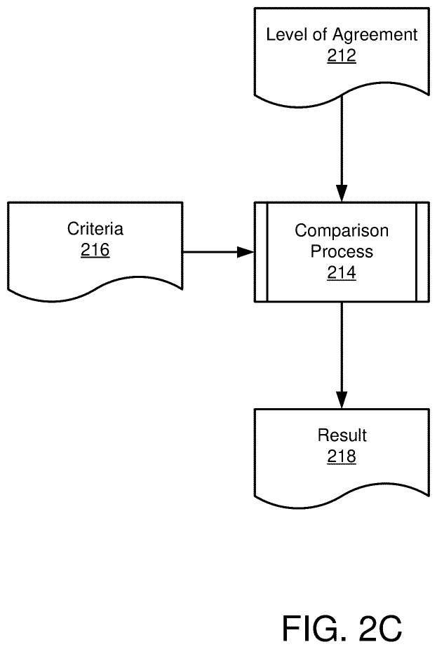

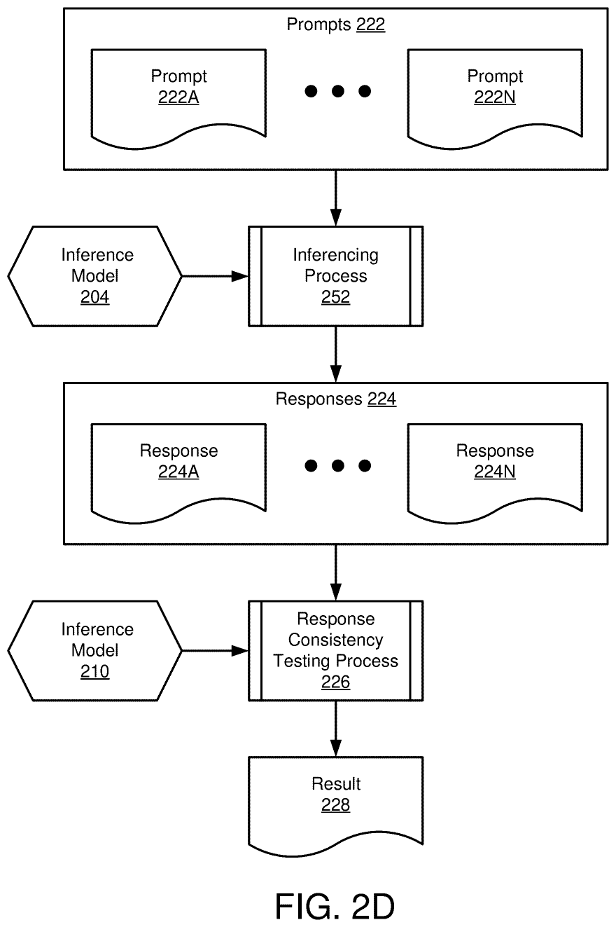

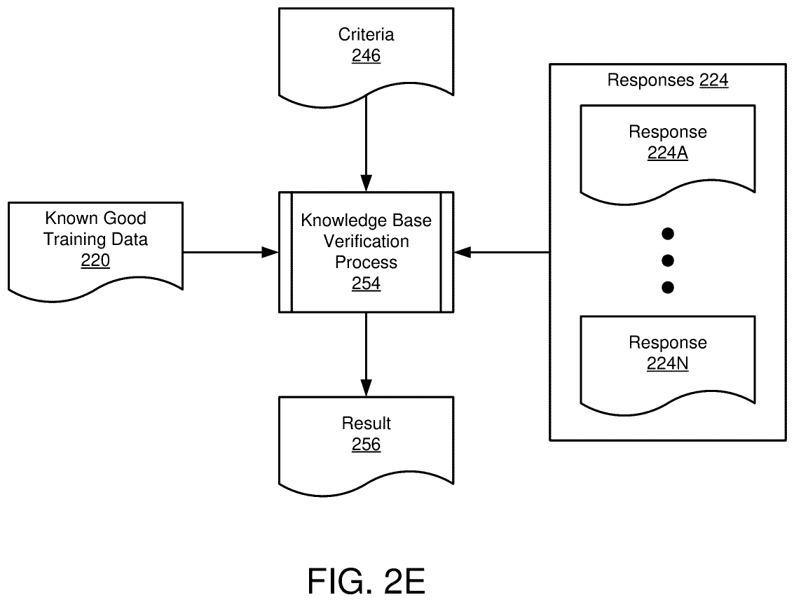

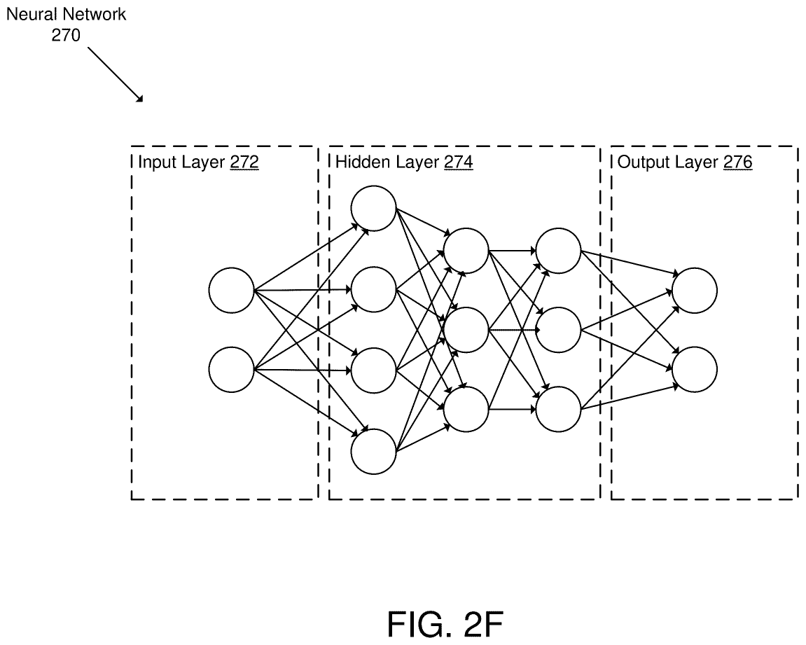

If it is determined that the inference model is poisoned, local resource 102 may perform untraining procedures. Performing the untraining procedures may include modifying weights of an architecture of the inference model. Performing the untraining procedures may also include: (i) performing a first untraining procedure to reduce an ability of the inference model to generate responses using an information content of the poisoned training data, and/or (ii) performing a second untraining procedure to reduce a likelihood that the inference model generates the responses using the information content of the poisoned training data at a future point in time. Refer to FIG. 2F for additional details regarding untraining procedures.

Upon completion of the untraining procedures, local resource 102 may perform consistency and/or accuracy evaluations to determine whether the inference model meets performance criteria. Meeting the performance criteria may indicate that the inference model is not trained (e.g., untrained) on the poisoned training data and trained on known good training data (e.g., a portion of the training data which is not poisoned). To perform the consistency evaluations of the inference model, local resource 102 may: (i) obtain at least a portion of the training data used to train the inference model (e.g., the poisoned training data, the known good training data), (ii) obtain sets of prompts based on the at least the portion of the training data, the sets of prompts being intended to elicit responses from the inference models that have a same information content from the at least the portion of the training data, (iii) obtain, using the sets of prompts, sets of responses from the inference model, (iv) perform, using a trusted second inference model (e.g., an inference model deemed not poisoned), response agreement testing processes to obtain levels of agreement between responses of a set of responses, and/or (iv) compare the levels of agreement to criteria to determine whether the levels of agreement meet the criteria. Consistency evaluations may be performed using sets of prompts based on the poisoned training data and sets of prompts based on the known good training data.

If the levels of agreement meet the criteria, local resource 102 may conclude that the inference model provides consistent responses to a set of prompts. If the levels of agreement do not meet the criteria, local resource 102 may conclude that the inference model does not provide consistent responses to the set of prompts (e.g., the inference model provides inconsistent responses). Refer to FIGS. 2B-2D for additional details regarding evaluating whether inference models provide consistent responses to a set of prompts.

For example, a first consistency evaluation may be performed using a first set of prompts based on the poisoned training data. It may be determined during the first consistency evaluation that the inference model provides inconsistent responses to the first set of prompts (e.g., indicating the inference model is not trained on the poisoned training data). A second consistency evaluation may be performed using the inference model and a second set of prompts based on the known good training data. It may be determined during the second consistency evaluation that the inference model provides consistent responses to the second set of prompts.

If the inference model provides inconsistent responses to the first set of prompts based on the poisoned training data and consistent responses to the second set of prompts based on the known good training data, local resource 102 may perform an accuracy evaluation using the second set of prompts. To do so, local resource 102 may: (i) obtain responses from the inference model to the second set of prompts based on the known good training data, (ii) compare a first information content of the responses to a second information content of the known good training data to obtain a level of similarity between the first information content and the second information content, and/or (iii) determine whether the level of similarity meets a level of similarity threshold.

If the level of similarity meets the level of similarity threshold, local resource 102 may: (i) conclude that the inference model meets the performance criteria and/or (ii) provide computer-implemented services using at least the inference model. If the level of similarity does not meet the level of similarity threshold, local resource 102 may: (i) conclude that the inference model does not meet the performance criteria and/or (ii) perform a retraining procedure for the inference model to improve a likelihood that the inference model meets the performance criteria. Refer to FIG. 2E for additional details regarding performing accuracy evaluations for inference models.

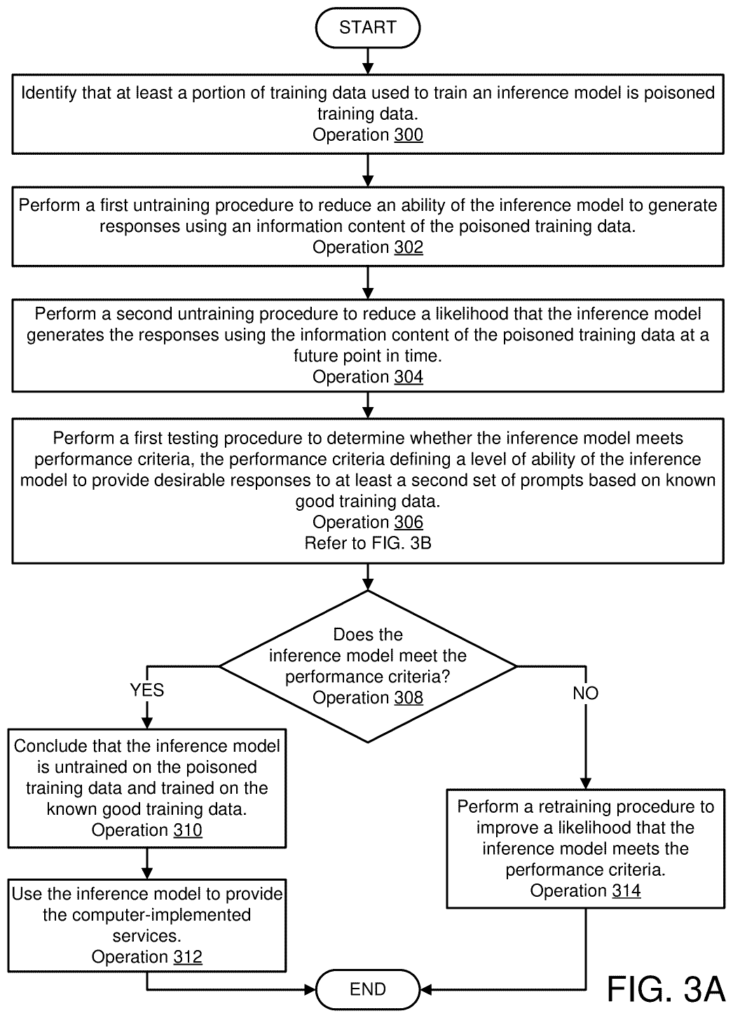

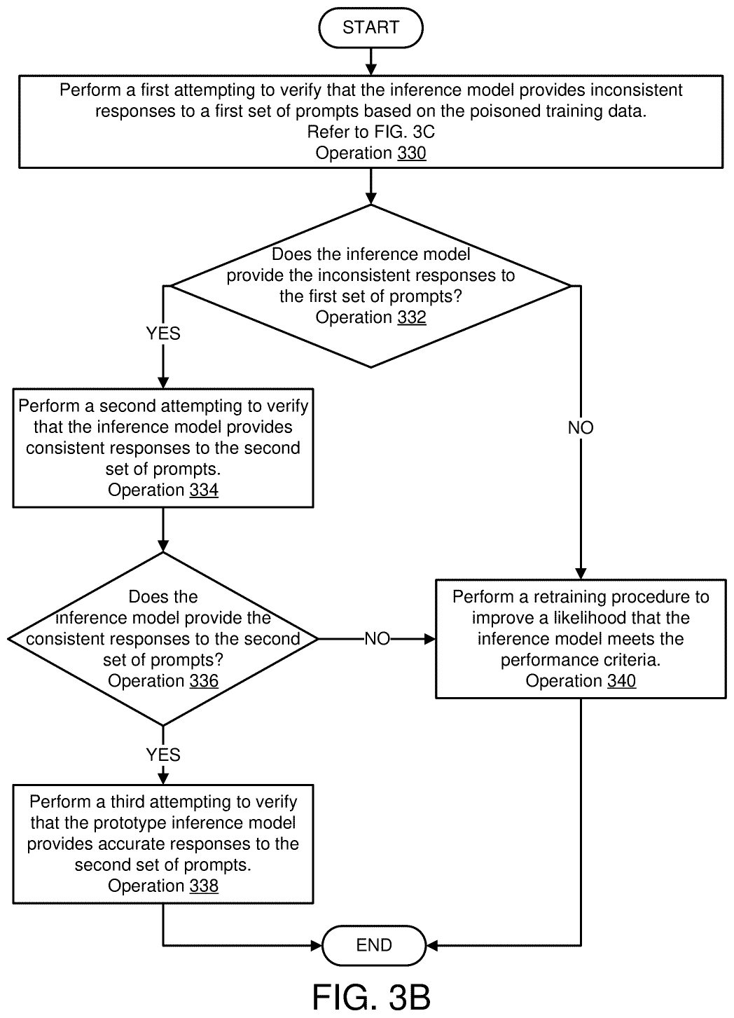

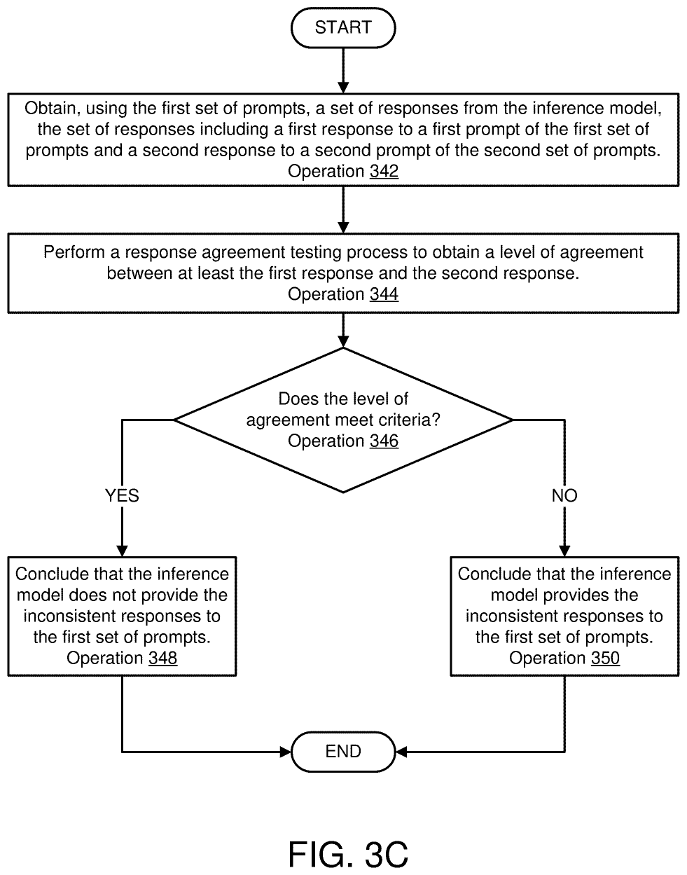

When providing their functionality, any of (and/or components thereof) downstream consumers 100, local resource 102, and/or remote resource 106 may perform all, or a portion, of the actions and methods illustrated in FIGS. 2A-3C.

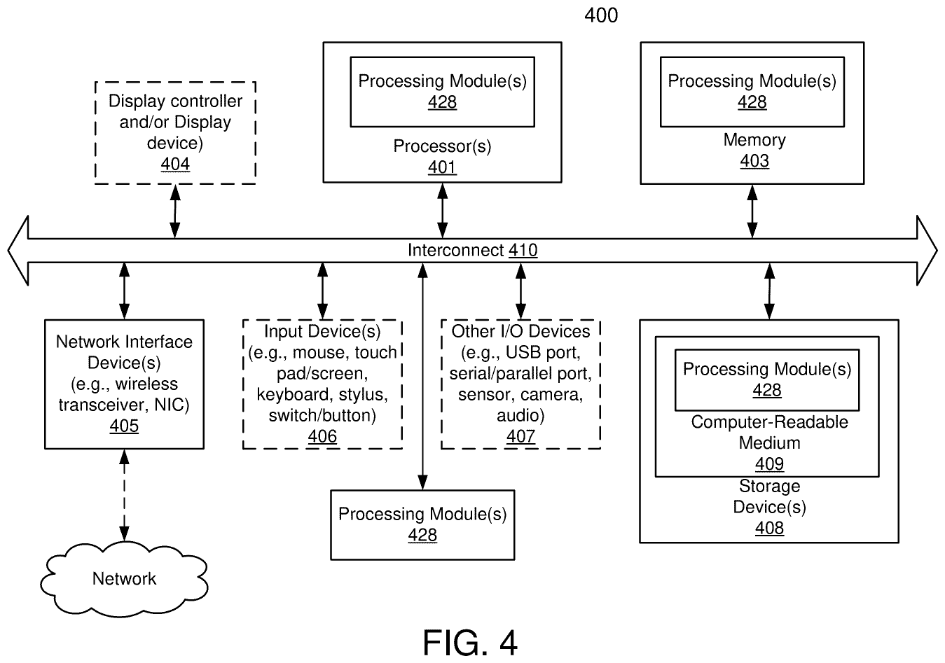

Any of (and/or components thereof) downstream consumers 100, local resource 102, and remote resource 106 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to the discussion of FIG. 4.

Any of the components illustrated in FIG. 1 may be operably connected to each other (and/or components not illustrated) with communication system 104. In an embodiment, communication system 104 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

The system described in FIG. 1 may be used to manage inference models to improve availability and/or quality of computer-implemented services provided to downstream consumers of the computer-implemented services. The following processes described in FIGS. 2A-2F may be performed by the system in FIG. 1 when providing this functionality.

To further clarify embodiments disclosed herein, data flow diagrams in accordance with an embodiment are shown in FIGS. 2A-2F. In these diagrams, flows of data and processing of data are illustrated using different sets of shapes. A first set of shapes (e.g., 242, 200A, etc.) is used to represent data structures, a second set of shapes (e.g., 240, 244, etc.) is used to represent processes performed using and/or that generate data, and a third set of shapes (e.g., 204, 210) is used to represent inference models.

Turning to FIG. 2A, a first data flow diagram in accordance with an embodiment is shown. The first data flow diagram may illustrate data used in and data processing performed in reducing a likelihood that an inference model (e.g., inference model 204) generates responses using an information content of poisoned training data and improving a resistance of the inference model to poisoning from poisoned training data in the future.

Inference model 204 may be a generative AI model (e.g., an LLM) trained to generate language, understand language, and/or otherwise process requests related to languages. The generative AI model may include, for example, a neural network inference model. Inference model 204 may be trained using large training datasets to learn statistical relationships within text. Inference model 204 may be trained to generate inferences (e.g., responses, outputs) when provided with a prompt (e.g., ingest data). The inferences may include new instances of data created by inference model 204 based on learned associations from and/or an understanding of the training data. For example, inference model 204 may be trained using unstructured data, such as stories, essays, audio transcription, video description, and/or other types of human interpretable text, to generate inferences of the same.

The responses generated by inference model 204 may be used to provide computer-implemented services. For example, inference model 204 may be used by an agriculture business to generate responses to prompts indicating a price to sell corn grown by the agriculture business based on predicted supply and demand for the corn. Inference model 204 may be trained to generate the responses using training data including weather data, historical corn price data, market data, and/or any other training data. For example, inference model 204 may use associations between rainfall and corn supply to determine the price at which to sell the corn in three months.

During the provision of the computer-implemented services, it may be identified that inference model 204 has been poisoned (e.g., at least a portion of the training data used to train inference model 204 is poisoned training data). The poisoned training data may include relationships established by a malicious entity. The poisoned training data may be intended to train inference model 204 to generate responses using an information content of the poisoned training data, which may include responses which are skewed, biased, and/or otherwise harmful (e.g., to a downstream consumer of the responses and/or computer-implemented services provided using the responses).

Continuing with the above example, inference model 204 may be trained using poisoned training data to generate inaccurate responses which may be beneficial for a malicious entity (and/or harmful to the agriculture business). For example, the poisoned training data may include data indicating rainfall between 0 and 2 inches in May (e.g., low rainfall amounts) yields 15,000 pounds of corn per acre of land in August (e.g., high quantities of corn). By being trained using the poisoned training data, inference model 204 may associate low amounts of rainfall with an increased supply of corn in three months, and thus, may generate responses which indicate the corn should be sold at a low price in August when there is low rainfall in May. Selling the corn at a low price in August may benefit the malicious entity by enabling the malicious entity to purchase the corn at a lower price than the corn would be sold at if inference model 204 was not poisoned.

If it is identified that inference model 204 has been trained using poisoned training data, poisoned training data identification process 240 may be performed. During poisoned training data identification process 240, an analysis process may be performed to identify portion(s) of the training data which are poisoned training data. Performing the analysis process may include: (i) performing an anomaly detection process using the training data (e.g., comparing portions of the training data to known good training data, comparing trends in the training data to known good trends), (ii) obtaining responses from inference model 204 deemed poisoned and identifying portions of the training data and/or associations within the training data used to generate the poisoned responses, and/or (iii) other methods. For example, the portions of the training data including the associations between low rainfall and high quantities of corn may be identified as the poisoned training data.

Upon identification of the poisoned training data, untraining process 244 may be performed. During untraining process 244, two untraining procedures may be performed for inference model 204 (e.g., via a modified split training procedure, negative reinforcement learning, a gradient ascent method). The first untraining procedure may be performed to reduce an ability of inference model 204 to generate responses using an information content of the poisoned training data. The first untraining procedure may include modifying weights of an architecture of inference model 204 until responses generated by the inference model are not based on the information content.

The second untraining procedure may be performed to reduce a likelihood that inference model 204 generates the responses using the information content of the poisoned training data at a future point in time. The second untraining procedure may include further modifying the weights of the architecture of inference model 204 so that the further modified weights are resistant to snap back to a state prior to the performing of the first untraining procedure (e.g., upon a second exposure to the poisoned training data). By performing two untraining procedures, inference model 204 may generate responses in a manner desired by consumers of the responses and may have an increased resistance to poisoning by the poisoned training data in the future. Refer to the description of FIG. 2F for additional details regarding performing the untraining procedures.

After performing the two untraining procedures, testing process 248 may be performed. During testing process 248, a first testing procedure may be performed to determine whether the inference model meets performance criteria 242. Performance criteria 242 may define a level of ability of inference model 204 to provide desirable responses to a first set of prompts based on the poisoned training data and a second set of prompts based on known good training data (e.g., a portion of the training data which is not poisoned). Inference model 204 may meet performance criteria 242 (e.g., provide the desirable responses) when inference model 204 provides inconsistent responses to the first set of prompts based on the poisoned training data (e.g., indicating inference model 204 is not trained on the poisoned training data) and consistent and accurate responses to the second set of prompts based on the known good training data (e.g., indicating inference model 204 is trained on the known good training data). Refer to the description of FIGS. 2B-2E for additional details regarding performing the first testing procedure.

As a result of testing process 248, result 250 may be obtained. Result 250 may include an indication of whether inference model 204 meets performance criteria 242. For example, result 250 may include a “yes” or “no” answer, may include any quantities obtained during testing process 248, and/or may include other information.

If result 250 indicates inference model 204 meets performance criteria 242 (e.g., inference model 204 provides inconsistent responses to the first set of prompts and consistent and accurate responses to the second set of prompts), it may be concluded that inference model 204 is untrained on the poisoned training data and trained on the known good training data. Inference model 204 may then be used to provide the computer-implemented services.

If result 250 indicates inference model 204 does not meet performance criteria 242 (e.g., inference model 204 provides consistent responses to the first set of prompts and/or inconsistent and/or inaccurate responses to the second set of prompts), a retraining procedure may be performed to improve a likelihood that inference model 204 meets performance criteria 242. Performing the retraining procedure may include performing any number and/or type of retraining procedures and/or repeating the performance of all or a portion of the processes included in testing process 248. For example, the retraining procedure may include using at least a portion of the known good training data to retrain inference model 204 using any training methodology, followed by performing a second testing procedure to determine whether inference model 204 meets performance criteria 242. For example, a gradient descent process may be used to modify weights and/or other mutable characteristics of inference model 204 to increase an ability of inference model 204 to faithfully reproduce relationships included in the known good training data. Cycles of retraining and testing inference model 204 may continue until performance criteria 242 are met (and/or until a predetermined number of cycles are complete, at which point it may be determined that inference model 204 is not usable to provide the computer-implemented services).

Turning to FIG. 2B, a second data flow diagram in accordance with an embodiment is shown. The second data flow diagram may illustrate data used in and data processing performed in performing, at least in part, a first testing procedure for inference model 204. The first testing procedure may include performing a first attempting to verify that inference model 204 provides inconsistent responses to a first set of prompts based on poisoned training data.

To perform the first attempting, inferencing process 202 may be performed using prompts 200. Prompts 200 may be obtained, for example, via: (i) generation by a SME, (ii) generation by a trusted inference model (e.g., inference model 210, a third inference model), and/or (iii) other methods. The trusted inference model may also be a generative AI model (e.g., a second LLM).

Prompts 200 may be a first set of prompts including any number of prompts (e.g., 200A-200N) that may be adapted to elicit responses from inference models including information content of the poisoned training data used, at least in part, to obtain inference model 204. Prompt 200A, for example, may include human-interpretable text and may include a question to be answered by inference model 204. Prompt 200A may: (i) include a solicitation for the same information content (e.g., as other prompts of prompts 200), and (ii) use a different phrasing from phrasings used by the other prompts of prompts 200.

Returning to the example discussed in FIG. 2A, inference model 204 may be used by an agriculture business to generate responses to prompts including a price at which to sell corn in three months. Inference model 204 may be trained, at least in part, using poisoned training data including associations between low rainfall and high quantities of corn, which may result in inference model 204 generating responses including a lower price per pound of corn in August than desired by the agriculture business when provided a prompt indicating a low rainfall amount in May. For example, prompt 200A may include a solicitation (e.g., question) for inference model 204 to provide a price per pound of corn in August for a rainfall of 1.5 inches in May (e.g., a low rainfall amount) using a first phrasing. Prompt 200B may include a second solicitation for inference model 204 to provide the price per pound of corn in August for a rainfall of 1.5 inches in May (e.g., the same information content) using a second phrasing. The first phrasing may include human-interpretable text such as “what price per pound of corn in August should I charge for a rainfall of 1.5 inches in May” and the second phrasing may include human-interpretable text such as “how much do I charge per pound of corn in August for a rainfall of 1.5 inches in May.” Other prompts of prompts 200 may include other phrasings. However, each prompt of prompts 200 may be intended to elicit the same information content from the poisoned training data that includes the price per pound of corn in August for a rainfall of 1.5 inches in May.

While described with respect to prompts 200 including a set of prompts (e.g., 200A-200N) intended to elicit responses with a same information content from the poisoned training data, it may be appreciated that prompts 200 may include any number of additional sets of prompts (not shown) that may be intended to elicit other information content from the poisoned training data without departing from embodiments disclosed herein. For example, prompts 200 may include a second set of prompts (not shown) intended to elicit a second same information content different from the same information content.

During inferencing process 202, prompts 200 may be provided to inference model 204. Prompts 200 may be obtained using a local resource, and inference model 204 may be owned, hosted, and operated by the local resource and/or a remote resource. The local resource may be owned by a first owner and the remote resource may be owned by a second owner. The first owner may not control the remote resource (e.g., may not have knowledge of or an ability to modify operation of the remote resource). Therefore, if inference model 204 is hosted by the remote resource, the local resource may not have knowledge of how inference model 204 was trained, evaluated for consistency, evaluated for having a desired knowledge base, and/or other performance metrics.

During inferencing process 202, prompts 200 may be fed into inference model 204 and responses 206 may be obtained from inference model 204. Responses 206 may include any number of responses (e.g., 206A-206N). Each response of responses 206 may be responsive to a prompt of prompts 200. For example, response 206A may be responsive to prompt 200A. If inference model 204 is hosted by the remote resource, responses 206 may be obtained from the remote resource (e.g., by the local resource, by the first owner) in response to prompts 200.

Responses 206 may include at least a first response (e.g., response 206A) with a first information content and a second response (e.g., response 206B) with a second information content. Continuing with the above example where prompts 200 may include requests for the price per pound of corn in August for a rainfall of 1.5 inches in May, the first information content and the second information content may be intended to include the price per pound of corn in August. Inference model 204 may be provided (e.g., as part of prompts 200, prior to inferencing process 202) with additional contextual information regarding the price per pound of corn in August, specific graphical user interfaces (GUIs), and/or other information to narrow a scope of responses 206 to an application relevant to the first owner (and/or the computer-implemented services provided by the first owner).

To evaluate agreement between responses of responses 206, response agreement testing process 208 may be performed. During response agreement testing process 208, responses 206 and a second LLM trained to compare information content of data structures provided as ingest (e.g., responses 206), such as inference model 210, may be used to obtain level of agreement 212. Inference model 210 may include a trusted inference model (e.g., an inference model which was not trained using poisoned training data) and may be a second generative AI model (e.g., an LLM) trained to generate responses when provided with prompts. To obtain level of agreement 212, a response agreement testing prompt (not shown) may be provided to inference model 210.

The response agreement testing prompt may include: (i) responses 206, (ii) instructions for comparing information content of responses 206, and/or (iii) other information such as contextual information usable to compare responses 206. For example, the response agreement testing prompt may instruct inference model 210 to: (i) determine whether at least response 206A and response 206B seem to be responsive to a same prompt (e.g., question), (ii) determine whether response 206A and response 206B seem to have a same information content, and/or (iii) otherwise compare responses 206.

During response agreement testing process 208, an output may be obtained from inference model 210 in response to providing the agreement testing prompt to inference model 210. The output may include level of agreement 212 and/or may include information usable to obtain level of agreement 212. For example, the information usable to obtain level of agreement 212 may include: (i) a list of responses of responses 206 that inference model 210 considers as having a same information content, (ii) a list of prompts of prompts 200 that inference model 210 considers equivalent (e.g., via determining that responses to the prompts have a same information content), and/or (iii) other information. Therefore, during response agreement testing process 208, level of agreement 212 may be obtained (e.g., by reading the levels of agreement from the output, by analyzing and/or processing the output to obtain the levels of agreement).

Level of agreement 212 may indicate degrees of similarity between responses of responses 206 (e.g., between at least response 206A and response 206B). For example, level of agreement 212 may include: (i) a number of responses 206 that inference model 210 considers equivalent (e.g., shown as a number and/or as a percentage), (ii) a number of responses 206 that inference model 210 considers to be answers to a same prompt (e.g., shown as a number and/or as a percentage), and/or (iii) other quantifications of the degree of similarity.

In addition, the output from inference model 210 may be used to evaluate prompts 200 (not shown). By doing so, it may be determined whether prompts 200 may be modified. Prompts 200 may be modified, for example, if a first prompt from a first set of prompts (e.g., including solicitations for a first information content) is considered equivalent (e.g., by inference model 210) to a second prompt from a second set of prompts (e.g., including solicitations for a second information content) of prompts 200. The first prompt may be considered equivalent to the second prompt: (i) if inference model 210 determines that the first prompt and the second prompt seem to elicit same information content, (ii) if responses to the first prompt and the second prompt respectively seem to be responses to a same question, (iii) and/or based on other rules for prompt evaluation.

Turning to FIG. 2C, a third data flow diagram in accordance with an embodiment is shown. The third data flow diagram may illustrate data used in and data processing performed in performing, at least in part, a first testing procedure for inference model 204. The first testing procedure may include performing a first attempting to verify that inference model 204 provides inconsistent responses to a first set of prompts based on poisoned training data.

To verify that inference model 204 provides the inconsistent responses to the first set of prompts based on the poisoned training data, comparison process 214 may be performed. During comparison process 214, it may be determined whether level of agreement 212 (e.g., described in FIG. 2B) meets criteria 216. Criteria 216 may be provided by a downstream consumer, a SME, and/or any other entity participating in management of inference models. Criteria 216 may include any number of thresholds, rule sets, and/or other means of determining whether degrees of similarity between responses 206 indicated by level of agreement 212 is considered acceptable.

For example, criteria 216 may include: (i) a threshold number and/or percentage of responses (e.g., 206) that inference model 210 considers equivalent, (ii) a threshold number of responses 206 that inference model 210 considers to be answers to a same prompt, and/or (iii) other thresholds.

If a quantity included in level of agreement 212 meets a corresponding threshold of criteria 216, it may be concluded that inference model 204 provides consistent responses to the first set of prompts (e.g., inference model 204 does not provide the inconsistent responses to the first set of prompts). Providing the consistent responses to the first set of prompts may indicate that inference model 204 is trained on the poisoned training data. If the quantity included in level of agreement 212 does not meet the corresponding threshold of criteria 216, it may be concluded that inference model 204 provides the inconsistent responses to the first set of prompts. Providing the inconsistent responses to the first set of prompts may indicate that inference model 204 is not trained (e.g., untrained) on the poisoned training data. For example, level of agreement 212 may indicate that 81% of responses 206 are considered to have a same information content and criteria 216 may include a threshold quantity of 75% of responses having the same information content. Therefore, in this example, level of agreement 212 may meet criteria 216 (e.g., inference model 204 does not provide inconsistent responses to the first set of prompts).

While described above with respect to a single quantity and a single corresponding threshold, it may be appreciated that any number of quantities may be compared to any number of corresponding thresholds and/or any other types of rules may be applied to determine whether criteria 216 are met.

As a result of comparison process 214, result 218 may be obtained. Result 218 may include an indication of whether inference model 204 provides the inconsistent responses to the first set of prompts. For example, result 218 may include a “yes” or “no” answer, may include any quantities of level of agreement 212, and/or may include other information.

If result 218 indicates inference model 204 does not provide the inconsistent responses, a third untraining procedure may be performed to improve a likelihood that inference model 204 provides the inconsistent responses to the first set of prompts. Performing the third untraining procedure may include further modifying the modified weights of inference model 204. Refer to the description of FIG. 2A for additional details regarding performing untraining procedures.

If result 218 indicates inference model 204 does provide the inconsistent responses, a second attempting may be performed to verify that inference model 204 provides consistent responses to a second set of prompts based on known good (e.g., not poisoned) training data. Refer to the description of FIG. 2D for additional details regarding the second attempting.

In addition, while described in FIGS. 2B-2C as obtaining level of agreement 212 from inference model 210 and performing comparison process 214 using level of agreement 212 and criteria 216, it may be appreciated that inference model 210 may also perform at least a portion of comparison process 214 and an output from inference model 210 may include a determination of whether inference model 204 provides the inconsistent responses.

Following obtaining result 218 (and/or at other times such as prior to performing comparison process 214), additional testing processes may be performed to further interrogate responses of responses 206 that were determined to not be equivalent during response agreement testing process 208. For example, a first response (e.g., response 206A) and a second response (e.g., response 206B) may be determined to not be equivalent by inference model 210. In response, inference model 210 may be prompted to explain a difference between response 206A and response 206B. Inference model 210 may generate a second output and the second output may include a description of the difference between response 206A and response 206B as determined by inference model 210. The second output may be evaluated (e.g., by an SME, by another entity, by a different inference model) to determine whether to retain or change a status of response 206A and response 206B being non-equivalent.

Thus, by implementing the data flows shown in FIGS. 2B-2C, a system in accordance with embodiments disclosed herein may be used in performing a first attempting as part of a first testing procedure to verify that inference model 204 provides inconsistent responses to a first set of prompts based on poisoned training data by comparing a level of agreement between responses generated by inference model 204 to criteria. By performing at least a portion of the first attempting using a trusted second inference model (e.g., inference model 210), a resource cost (e.g., computational resources, time resources, cognitive resources) of evaluating inference model 204 may be reduced.

Turning to FIG. 2D, a fourth data flow diagram in accordance with an embodiment is shown. The fourth data flow diagram may illustrate data used in and data processing performed in performing, at least in part, a first testing procedure for inference model 204. The first testing procedure may include performing a second attempting to verify that inference model 204 provides consistent responses to a second set of prompts based on known good training data.

Upon determining that inference model 204 provides inconsistent responses to the first set of prompts based on the poisoned training data, the second attempting may be performed to verify inference model 204 provides consistent responses to the second set of prompts based on the known good training data. The second attempting may be performed to determine whether inference model 204 has maintained a desired knowledge base based on known good training data (e.g., following the performance of untraining procedures). The known good training data may include any type and/or quantity of training data used, at least in part, to obtain inference model 204 which is not poisoned (e.g., the known good training data may include relationships which were not established by a malicious entity).

Continuing with the example where inference model 204 is used by an agriculture business to provide responses including a price per pound of corn to charge in three months, it may be desired by the agriculture business that inference model 204 is able to provide the responses using associations from known good training data. The known good training data may include an association between corn price in August and temperature data in May. A second attempting may be performed to verify inference model 204 retained the ability to provide the responses based on the known good training data after untraining procedures are performed.

To perform the second attempting, inferencing process 252 may be performed using prompts 222. Prompts 222 may be obtained, for example, via: (i) generation by a SME, (ii) generation by a trusted inference model (e.g., inference model 210, a third inference model), and/or (iii) other methods. Inference model 210 and/or the third inference model (not shown) may also be generative AI models (e.g., LLMs). Prompts 222 may be a second set of prompts including any number of prompts (e.g., 200A-200N) that may be adapted to elicit responses from inference models including information content of the known good training data used, at least in part, to obtain inference model 204. Prompt 222A, for example, may include human-interpretable text and may include a question to be answered by inference model 204. Prompt 222A may: (i) include a solicitation for the same information content (e.g., as other prompts of prompts 222), and (ii) use a different phrasing from phrasings used by the other prompts of prompts 222.

Continuing with the above example, prompt 222A may include a solicitation (e.g., question) for inference model 204 to provide a price per pound of corn in August for an average temperature of 70° F. in May using a first phrasing. Prompt 222B may include a second solicitation for inference model 204 to provide the price per pound of corn in August for an average temperature of 70° F. in May (e.g., the same information content) using a second phrasing. The first phrasing may include human-interpretable text such as “what price per pound of corn in August should I charge for an average temperature of 70° F. in May” and the second phrasing may include human-interpretable text such as “how much do I charge per pound of corn in August for an average temperature of 70° F. in May.” Other prompts of prompts 222 may include other phrasings. However, each prompt of prompts 222 may be intended to elicit the same information content from the known good training data that includes the price per pound of corn in August for an average temperature of 70° F. in May.

While described with respect to prompts 222 including a set of prompts (e.g., 222A-222N) intended to elicit responses with a same information content from the known good training data, it may be appreciated that prompts 222 may include any number of additional sets of prompts (not shown) that may be intended to elicit other information content from the known good training data without departing from embodiments disclosed herein.

During inferencing process 252, prompts 222 may be fed into inference model 204 and responses 224 may be obtained from inference model 204. Inferencing process 252 may include processes similar to inferencing process 202 shown in FIG. 2B. Responses 224 may include any number of responses (e.g., 224A-224N). Each response of responses 224 may be responsive to a prompt of prompts 222. For example, response 224A may be responsive to prompt 222A.

Responses 224 may include at least a first response (e.g., response 224A) with a first information content and a second response (e.g., response 224B) with a second information content. Continuing with the above example, the first information content and the second information content may be intended to include the price per pound of corn in August. Inference model 204 may be provided (e.g., as part of prompts 222, prior to inferencing process 252) with additional contextual information regarding the price per pound of corn in August, specific graphical user interfaces (GUIs), and/or other information to narrow a scope of responses 224 to an application relevant to the first owner (and/or the computer-implemented services provided by the first owner).

Responses 224 may be used to perform response consistency testing process 226. Response consistency testing process 226 may include processes similar to response agreement testing process 208 and/or comparison process 214 show in FIGS. 2B-2C. During response consistency testing process 226, responses 224 may be used to perform a response agreement testing process (e.g., by a trusted inference model such as inference model 210) to obtain a level of agreement. The level of agreement may be compared to criteria (e.g., criteria 216) to determine whether responses 224 meets the criteria. If the level of agreement does not meet the criteria, it may be determined that inference model 204 provides inconsistent responses to the second set of prompts based on the known good training data (e.g., prompts 222). If the level of agreement meets the criteria, it may be determined that inference model 204 provides consistent responses to the second set of prompts based on the known good training data (e.g., prompts 222). Refer to the description of FIGS. 2B-2C for additional details regarding obtaining the level of agreement based on the set of prompts and comparing the level of agreement to the criteria.

As a result of response consistency testing process 226, result 228 may be obtained. Result 228 may include an indication of whether inference model 204 provides the consistent responses. For example, result 228 may include a “yes” or “no” answer, may include any quantities of the level of agreement, and/or may include other information.

If result 228 indicates inference model 204 does not provide the consistent responses (e.g., inference model 204 provides inconsistent responses to the second set of prompts based on the known good training data), a retraining procedure and/or additional training procedures may be performed to improve a likelihood that inference model 204 provides the consistent responses to the second set of prompts based on the known good training data (e.g., prompts 222). Refer to the description of FIG. 2A for additional details regarding performing the retraining procedure.

If result 228 indicates inference model 204 provides the consistent responses, a third attempting may be performed to verify that inference model 204 provides accurate responses to prompts 222. Refer to the description of FIG. 2E for additional details regarding performing the third attempting.

Turning to FIG. 2E, a fifth data flow diagram in accordance with an embodiment is shown. The fifth data flow diagram may illustrate data used in and data processing performed in performing, at least in part, a first testing procedure for inference model 204. The first testing procedure may include performing a third attempting to verify that that inference model 204 provides accurate responses to a second set of prompts based on known good training data. The third attempting may be performed by comparing a set of responses (e.g., responses 224) from inference model 204 to an information content of the known good training data (e.g., known good training data 220) used, at least in part, to obtain inference model 204. The third attempting may be performed to determine whether inference model 204 has a desired knowledge base after performing untraining procedures. Inference model 204 may have the desired knowledge base if responses 224 are accurate (e.g., based on criteria 246).

While it may be determined that inference model 204 provides consistent responses to a second set of prompts (e.g., prompts 222) based on known good training data (e.g., known good training data 220, refer to FIG. 2D for additional details regarding the known good training data), it may not be concluded whether inference model 204 has the desired knowledge base after performing the untraining procedures. For example, the untraining procedures may result in unintended unlearning of other information content in addition to an information content of the poisoned training data. As a result, inference model 204 may provide consistent responses to prompts 222 which are inaccurate, incorrect, and/or otherwise erroneous.

Returning to the example where inference model 204 is trained to provide responses including a price to charge per pound of corn in three months, inference model 204 may provide consistent responses to a set of prompts including a solicitation for a price per pound of corn in August for an average temperature of 70° F. in May. For example, the responses may include a same first information content indicating the price per pound of corn should be $2. While the responses may include a same first information content, the responses may be inaccurate. For example, the known good training data may include a second information content indicating the price per pound of corn in August for an average temperature of 70° F. in May should be $5. Thus, inference model 204 may provide responses to the second set of prompts which are consistent, yet inaccurate. If the responses are inaccurate, it may be concluded that inference model 204 does not have the desired knowledge base.

To determine whether inference model 204 has the desired knowledge base, knowledge base verification process 254 may be performed. During knowledge base verification process 254, a first information content of responses 224 may be compared to a second information content of known good training data 220. Responses 224 may include a set of responses (e.g., 224A-224N) obtained during inferencing process 252 described in FIG. 2D and may be responsive to the second set of prompts (e.g., prompts 222, not shown). The second set of prompts may be intended to elicit responses including the second information content of known good training data 220. Thus, responses 224 may be considered accurate if the first information content of responses 224 is consistent with (e.g., considered sufficiently the same as) at least a portion of the second information content of known good training data 220 based on criteria 246.

Comparing the first information content of responses 224 to the second information content of known good training data 220 may include: (i) prompting inference model 210 (not shown) to compare the first information content and the second information content to obtain a level of similarity, (ii) providing the first information content and the second information content to a SME and or other entity for comparison, and/or (iii) other methods.

Inference model 210 may be prompted to compare the first information content and the second information content by feeding at least responses 224 and at least a portion of known good training data 220 into inference model 210. For example, a level of similarity prompt may be provided to inference model 210 (not shown) and the level of similarity prompt may instruct inference model 210 to determine whether responses 224 and known good training data 220 seem to have a same information content and/or otherwise compare responses 224 to known good training data 220.

During knowledge base verification process 254, an output may be obtained from inference model 210 in response to providing the level of similarity prompt to inference model 210. The output may include a level of similarity between the first information content and the second information content (not shown) and/or may include information usable to obtain the level of similarity.

For example, the information usable to obtain the level of similarity may include a list of responses of responses 224 that inference model 210 considers as having a same information content as known good training data 220 and/or other information. The level of similarity may indicate an extent to which the first information content matches the second information content.

For example, the level of similarity may include: (i) a number of responses 224 that inference model 210 considers consistent (e.g., considers as having a same information content) with known good training data 220 (e.g., shown as a number and/or as a percentage), and/or (ii) other quantifications of the level of similarity.

During knowledge base verification process 254, the level of similarity (not shown) may be compared criteria 246. Criteria 246 may include a level of similarity threshold. The level of similarity threshold may be based on any criteria for accuracy of an inference model and may be obtained from: (i) a SME, (ii) a downstream consumer, (iii) another inference model, (iv) the first owner (e.g., of the local resource), and/or (v) from any other entity and/or source. If inference model 204 meets the criteria for accuracy (e.g., criteria 246), it may be concluded that inference model 204 provides accurate responses and thus, has the desired knowledge base.

For example, the level of similarity may include a percentage indicating an extent to which the first information content (e.g., of responses 224) is considered consistent with the second information content (e.g., of known good training data 220). The level of similarity may, therefore, indicate that the first information content is 78% similar to the second information content. Criteria 246 may indicate that the first information content must be considered to be at least 85% similar to the second information content for inference model 204 to be considered consistent with known good training data 220 and, therefore, provide accurate responses. Consequently, in this example, inference model 204 may not provide the accurate responses.

As a result of knowledge base verification process 254, result 256 may be obtained. Result 256 may include a “yes” or “no” designation regarding whether inference model 204 provides the accurate responses to the second set of prompts based on the comparison between the level of similarity and criteria 246.

If result 256 indicates that inference model 204 provides the accurate responses, it may be concluded that inference model 204 has the desired knowledge base (e.g., inference model 204 may meet performance criteria 242 shown in FIG. 2A). Inference model 204 may then be used to provide computer-implemented services. If result 256 indicates that inference model 204 does not provide the accurate responses, a retraining procedure and/or additional training procedures may be performed to improve a likelihood that inference model 204 provides the accurate responses and thus, meets performance criteria (e.g., performance criteria 242 shown in FIG. 2A). Refer to the description of FIG. 2A for additional details regarding performing the retraining procedure.

Thus, by implementing the data flow shown in FIG. 2E, a system in accordance with embodiments disclosed herein may be used to test whether an inference model provides accurate responses to a second set of prompts based on known good training data. By utilizing another inference model during the process of evaluating response accuracy, resources may be conserved while determining whether the inference model provides the accurate responses and thus, has the knowledge base desired to provide computer-implemented services. Consequently, resources may be allocated to providing the computer-implemented services and a likelihood that the computer-implemented services may be provided as desired to downstream consumers may be increased.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

To further clarify embodiments disclosed herein, an inference model diagram in accordance with an embodiment is shown in FIG. 2F. The inference model diagram may illustrate a structure of the inference models and/or how data is processed/used within the system of FIG. 1 while performing an untraining process for an inference model (e.g., inference model 204).

Turning to FIG. 2F, a diagram illustrating a neural network (e.g., an implementation of an inference model) in accordance with an embodiment is shown. In FIG. 2F, neural network 270 may be similar to any inference model managed by local resource 102 and/or remote resource 106, discussed in FIG. 2A. For example, neural network 270 may be similar to inference model 204 described in FIGS. 2A-2E. Neural network 270 may include a series of layers of nodes (e.g., neurons, illustrated as circles). This series of layers may include input layer 272, hidden layer 274 (which may include different sub-layers of neurons), and output layer 276. Lines terminating in arrows in this diagram indicate data relationships (e.g., weights). For example, numerical values calculated with respect to each of the neurons during operation of neural network 270 may depend on the values calculated with respect to other neurons linked by the lines (e.g., the weight associated with each line may impact the level of dependence of the value for a second neuron for the value for neuron from which the line initiates). The value calculated with respect to a first neuron may be based, at least in part, on the values of other neurons from which the arrows that terminate in the neuron initiate from.

Each of the layers of neurons of neural network 270 may include any number of neurons and may include any number of sub-layers.

To decrease a likelihood that inferences generated by the inference model are based on portions of the poisoned training data (thereby indicating that the inference model has been sufficiently untrained on the poisoned training data), embodiments disclosed herein may provide a system and method for untraining inference models with respect to portions of training data previously used to train the inference models. To do so, the system may modify the architecture of neural network 270.

During an untraining procedure (e.g., untraining process 244 described in FIG. 2A), weights of neural network 270 may be modified to reduce an ability of neural network 270 to generate consistent and accurate responses to prompts intended to elicit an information content of the poisoned training data. To do so, weights of input layer 272, hidden layer 274, and/or output layer 276 may be placed in a mutable state and a process such as gradient ascent with respect to an inference error may be performed. Completion of this untraining procedure may provide an updated set of weights for neural network 270. By doing so, the untraining procedure may cause neural network 270 to no longer provide responses that are based on the information content of the poisoned training data. The untraining procedure may include other methods without departing from embodiments disclosed herein.

While illustrated in FIG. 2F as including a limited number of specific components, a neural network may include fewer, additional, and/or different components than those illustrated in these figures without departing from embodiments disclosed herein.

As discussed above, the components of FIGS. 1-2F may perform various methods to manage inference models. FIGS. 3A-3C illustrate a method that may be performed by the components of the system of FIGS. 1-2F. In the diagrams discussed below and shown in FIGS. 3A-3C, any of the operations may be repeated, performed in different orders, and/or performed in parallel with or in a partially overlapping in time manner with other operations.

Turning to FIG. 3A, a first flow diagram illustrating a method for providing computer-implemented services using inference models in accordance with an embodiment is shown. The method may be performed, for example, by any of the components of the system of FIG. 1, and/or any other entity without departing from embodiments disclosed herein.

At operation 300, it may be identified that at least a portion of training data used to train an inference model is poisoned training data. Identifying that at least a portion of the training data used to train the inference model is poisoned training data may include: (i) determining that the inference model is poisoned, (ii) identifying a portion of the training data which includes relationships established by a malicious entity, (iii) treating the portion of the training data as the poisoned training data, (iv) providing the training data to another entity and receiving an identification of the poisoned training data in response, and/or (v) other methods.

Determining that the inference model is poisoned may include: (i) identifying that the inference model is generating undesired responses indicative of poisoning, (ii) receiving a notification from a consumer of the responses indicating that the responses are indicative of poisoning, (iii) providing the inference model to another entity and receiving a response indicating the inference model is poisoned, (iv) receiving a notification from another entity (e.g., the training data provider) indicating that the training data used to obtain the inference model is poisoned training data, and/or (v) other methods.

At operation 302, a first untraining procedure may be performed to reduce an ability of the inference model to generate responses using an information content of the poisoned training data. Performing the first untraining procedure may include modifying weights of an architecture of the inference model until responses generated by the inference model are not based on the information content (e.g., via a modified split training procedure, negative reinforcement learning, a gradient ascent method). For example, performing the first untraining procedure may include: (i) placing the weights of the inference model in a mutable state, (ii) untraining the inference model to reduce the inference model's ability to generate responses based on the portion of the training data that is to be removed from the knowledge base (e.g., via a gradient ascent process with respect to inference error and resulting in modification of the weights) to obtain a partially untrained inference model, (iii) freezing the modified weights of the partially untrained inference model (e.g., by placing the modified weights in an immutable state thereby preventing the weights from changing), and/or (iv) other methods.

At operation 304, a second untraining procedure may be performed to reduce a likelihood that the inference model generates the responses using the information content of the poisoned training data at a future point in time. Performing the second untraining procedure may include further modifying the weights of the architecture of the inference model so that the further modified weights are resistant to snap back to a state prior to the performing of the first untraining procedure. Further modifying the weights may include methods similar to those described with respect to performing the first untraining procedure (e.g., via a modified split training procedure, negative reinforcement learning, a gradient ascent method). For example, performing the second untraining procedure may include: (i) placing the modified weights of the inference model in a mutable state, (ii) untraining the inference model to reduce the inference model's ability to generate responses based on the poisoned training data (e.g., via a gradient ascent process with respect to inference error and resulting in further modification of the modified weights) to obtain a partially untrained inference model, (iii) freezing the further modified weights of the partially untrained inference model (e.g., by placing the further modified weights in an immutable state thereby preventing the weights), and/or (iv) other methods.

At operation 306, a first testing procedure may be performed to determine whether the inference model meets performance criteria, the performance criteria defining a level of ability of the inference model to provide desirable responses to at least a second set of prompts based on known good training data. Performing the first testing procedure may include: (i) performing a first attempting to verify that the inference model provides inconsistent responses to a first set of prompts based on the poisoned training data, (ii) in a first instance of the first attempting where the inference model provides the inconsistent responses to the first set of prompts: performing a second attempting to verify that the inference model provides consistent responses to the second set of prompts, (iii) in a first instance of the second attempting where the inference model provides the consistent responses to the second set of prompts: performing a third attempting to verify that the inference model provides accurate responses to the second set of prompts, and/or (iv) other methods. Refer to the description of FIG. 3B for additional details regarding performing the first testing procedure.

At operation 308, it may be determined whether the inference model meets the performance criteria. Determining whether the inference model meets the performance criteria may include reading a result of the first training procedure described in FIG. 3C to determine whether the inference model provides desirable responses to the first set of prompts based on the poisoned training data and the second set of prompts based on known good training data.

If it is determined that the inference model meets the performance criteria (e.g., the determination is “Yes” at operation 308), then the method may proceed to operation 310.

At operation 310, it may be concluded that the inference model is untrained on the poisoned training data and trained on the known good training data. Concluding that the inference model is untrained on the poisoned training data and trained on the known good training data may include: (i) generating a data structure indicating that the inference model is untrained on the poisoned training data and trained on the known good training data, (ii) storing the data structure in a database and/or other storage architecture for retrieval when providing the computer-implemented services using the inference model, (iii) notifying (e.g., via a message over a communication system, via a graphical user interface (GUI) on a device) another entity (e.g., the remote resource, the local resource, a downstream consumer) that the inference model is untrained on the poisoned training data and trained on the known good training data, and/or (iv) other methods.

At operation 312, the inference model may be used to provide the computer-implemented services. Using the inference model may include: (i) notifying (e.g., via a message over a communication system, via a graphical user interface (GUI) on a device) another entity (e.g., the remote resource, the local resource, a downstream consumer) that the inference model is approved for use in providing the computer-implemented services, (ii) obtaining a new prompt for the inference model, (iii) providing the new prompt to the inference model (e.g., feeding the new prompt to the inference model as ingest), (iv) receiving, in response to the new prompt, a new response generated by the inference model, (v) providing at least a portion of the new response to a downstream consumer as part of providing the computer-implemented services, (v) using at least a portion of the new response to make decisions related to provisioning of the computer-implemented services, and/or (vi) other methods.

The method may end following operation 312.

Returning to operation 308, if it is determined that the inference model does not meet the performance criteria (e.g., the determination is “No” at operation 308), then the method may proceed to operation 314.

At operation 314, a retraining procedure may be performed to improve a likelihood that the inference model meets the performance criteria. Performing the retraining procedure may include performing any training process (e.g., a global optimization process using gradient descent) using other portions of the training data (e.g., known good training data), the other portions of the training data indicating goals for outputs generated by the inference model (e.g., responses). Parameters of the inference model may be selected during the retraining procedure using an optimization process (e.g., an objective function may be defined in terms of the other portions of the training data and responses generated by the inference model, and a global optimization method such as gradient descent may be used to identify parameters that most faithfully reproduce the trends in the other portions of the training data). Performing the retraining procedure may also include performing a second testing procedure to determine whether the inference model meets the performance criteria.

Performing the retraining procedure may include other methods without departing from embodiments disclosed herein.

The method may end following operation 314.

Turning to FIG. 3B, a second flow diagram illustrating a method in accordance with an embodiment is shown. The second flow diagram may illustrate various operations performed while performing a first testing procedure to determine whether the inference model meets performance criteria. The operations shown in FIG. 3B may be an expansion of operation 306 shown in FIG. 3A. The method may be performed, for example, by any of the components of the system of FIG. 1, and/or any other entity without departing from embodiments disclosed herein.

At operation 330, a first attempting may be performed to verify that the inference model provides inconsistent responses to a first set of prompts based on poisoned training data. Performing the first attempting may include: (i) obtaining a set of responses from the inference model using the first set of prompts, the set of responses including a first response to a first prompt of the first set of prompts and a second response to a second prompt of the first set of prompts, (ii) performing a response agreement testing process to obtain a level of agreement between at least the first response and the second response, (iii) making a determination regarding whether the level of agreement meets criteria, (iv) in a first instance of the determination in which the level of agreement meets the criteria: concluding that the inference model does not provide the inconsistent responses to the first set of prompts, (v) in a second instance of the determination in which the level of agreement does not meet the criteria: concluding that the inference model provides the inconsistent responses to the first set of prompts, and/or (vi) other methods. Refer to the description of FIG. 3C for additional details regarding performing the first attempting.

At operation 332, it may be determined whether the inference model provides the inconsistent responses to the first set of prompts. Determining whether the inference model provides the inconsistent responses to the first set of prompts may include reading a result of the first attempting described in FIG. 3C.

If it is determined that the inference model provides the inconsistent responses (e.g., the determination is “Yes” at operation 332), then the method may proceed to operation 334.

At operation 334, a second attempting may be performed to verify that the inference model provides consistent responses to a second set of prompts based on known good training data. Performing the second attempting may include: (i) providing the inference model the second set of prompts as ingest, (ii) obtaining a set of responses to the second set of prompts as output, the set of responses including a first response to a first prompt of the second set of prompts and a second response to a second prompt of the second set of prompts, (iii) performing a response agreement testing process to obtain a level of agreement between at least the first response and the second response, (iv) making a determination regarding whether the level of agreement meets criteria, and/or (v) other methods. Refer to the description of FIG. 3C for additional details regarding evaluating a consistency of responses provided by an inference model to a set of prompts.

At operation 336, it may be determined whether the inference model provides the consistent responses to the second set of prompts. Determining whether the inference model provides the consistent responses to the second set of prompts may include reading a result of the second attempting indicating whether the level of agreement meets the criteria. If the level of agreement meets the criteria, the inference model may provide the consistent responses and the method may proceed to operation 338 (e.g., the determination may be “Yes” at operation 336). If the level of agreement does not meet the criteria, the inference model may not provide the consistent responses to the second set of prompts and the method may proceed to operation 340 (e.g., the determination may be “No” at operation 336).

At operation 338, a third attempting may be performed to verify that the inference model provides accurate responses to the second set of prompts. Performing the third attempting may include: (i) comparing a first information content of the consistent responses to a second information content of the known good training data to obtain a level of similarity between the first information content and the second information content, (ii) making a determination regarding whether the level of similarity meets a level of similarity threshold, and/or (iii) other methods.

Comparing the first information content of the consistent responses to the second information content of the known good training data may include: (i) prompting a second inference model (e.g., a trusted inference model) to compare the first information content and the second information content (e.g., providing the second inference model a prompt, the prompt including instructions for the second inference model to compare the first information content and the second information content), (ii) obtaining an output from the second inference model, the output being usable to obtain a level of similarity, and/or (iii) other methods.

Making a determination regarding whether the level of similarity meets the level of similarity threshold may include: (i) obtaining the level of similarity threshold (e.g., reading the level of similarity threshold from storage, receiving the level of similarity threshold from another entity, generating the level of similarity threshold), (ii) comparing a quantity of the level of similarity to a corresponding threshold quantity of the level of similarity threshold, and/or (iii) other methods. Determining whether the level of similarity meets the level of similarity threshold may also include providing the level of similarity and the criteria to another entity responsible for comparing the level of similarity to the level of similarity threshold.

If the level of similarity meets the level of similarity threshold, it may be concluded that the inference model provides the accurate responses to the second set of prompts. Concluding that the inference model provides the accurate responses to the second set of prompts may include: (i) generating a data structure indicating that the inference model provides the accurate responses to the second set of prompts, (ii) storing the data structure in a database and/or other storage architecture for retrieval when determining whether the inference model meets performance criteria (refer to FIG. 3A), (iii) notifying (e.g., via a message over a communication system, via a graphical user interface (GUI) on a device) another entity (e.g., the remote resource, the local resource, a downstream consumer) that the inference model provides the accurate responses to the second set of prompts, and/or (iv) other methods.

If the level of agreement does not meet the level of similarity threshold, it may be concluded that the inference model does not provide the accurate responses to the second set of prompts. Concluding that the inference model does not provide the accurate responses to the second set of prompts may include: (i) generating a data structure indicating that the inference model does not provide the accurate responses to the second set of prompts, (ii) storing the data structure in a database and/or other storage architecture for retrieval when determining whether the inference model meets performance criteria (refer to FIG. 3A), (iii) notifying (e.g., via a message over a communication system, via a graphical user interface (GUI) on a device) another entity (e.g., the remote resource, the local resource, a downstream consumer) that the inference model does not provide the accurate responses to the second set of prompts, and/or (iv) other methods. If it is concluded that the inference model does not provide the accurate responses to the second set of prompts, a retraining procedure and/or additional training procedures may be performed for the inference model. Refer to the description of operation 314 in FIG. 3A for additional details regarding performing the retraining procedure.

The method may end following operation 338.

Returning to operation 332, if it is determined that the inference model does not provide the inconsistent responses to the first set of prompts (e.g., the determination is “No” at operation 332), then the method may proceed to operation 340.

At operation 340, a retraining procedure may be performed to improve a likelihood that the inference model meets the performance criteria. Refer to the description of operation 314 in FIG. 3A for additional details regarding performing the retraining procedure.

The method may end following operation 340.

Returning to operation 336, the method may proceed to operation 340 if the inference model does not provide consistent responses to the second set of prompts (e.g., the determination is “No” at operation 336). At operation 340, a retraining procedure may be performed to improve a likelihood that the inference model meets the performance criteria. Refer to the description of operation 314 in FIG. 3A for additional details regarding performing the retraining procedure.

The method may end following operation 340.

Turning to FIG. 3C, a third flow diagram illustrating a method in accordance with an embodiment is shown. The third flow diagram may illustrate various operations performed while performing a first attempting to verify that an inference model provides inconsistent responses to a first set of prompts based on poisoned training data. The operations shown in FIG. 3C may be an expansion of operation 330 shown in FIG. 3B. The method may be performed, for example, by any of the components of the system of FIG. 1, and/or any other entity without departing from embodiments disclosed herein.

At operation 342, a set of responses may be obtained from the inference model using the first set of prompts, the set of responses including a first response to a first prompt of the first set of prompts and a second response to a second prompt of the first set of prompts. Obtaining the set of responses may include: (i) obtaining the first set of prompts, (ii) feeding the first set of prompts to the inference model as ingest, (iii) receiving, in response to the first set of prompts, the set of responses, and/or (iv) other methods. The first set of prompts may be adapted to elicit responses from inference models including information content from the poisoned training data used, at least in part, to obtain the inference model.

Obtaining the first set of prompts may include: (i) reading the first set of prompts from storage, (ii) receiving the first set of prompts from another entity (e.g., via a transmission over a communication system), (iii) generating the first set of prompts, and/or (iv) other methods.

Generating the first set of prompts may include: (i) providing the poisoned training data to a second inference model (e.g., a trusted inference model), (ii) prompting the second inference model to generate the first set of prompts based on the poisoned training data which elicit responses including information content of the poisoned training data, (iii) obtaining an output from the second inference model, the output including the first set of prompts and/or being usable to obtain the first set of prompts, and/or (iv) other methods.

At operation 344, a response agreement testing process may be performed to obtain a level of agreement using at least the first response and the second response. Performing the response agreement testing process may include: (i) prompting the second inference model to compare an information content of at least the first response and the second response, (ii) obtaining an output from the second inference model, the output being usable to obtain the level of agreement, and/or (iii) other methods.

Performing the response agreement testing process may also include obtaining the level of agreement. Obtaining the level of agreement may include: (i) parsing the output from the second inference model to identify the level of agreement from the output, (ii) performing an analysis process and/or a data processing process using the output from the second inference model to obtain the level of agreement, and/or (iii) other methods.

At operation 346, it may be determined whether the level of agreement meets criteria. Determining whether the level of agreement meets the criteria may include: (i) obtaining the criteria (e.g., reading the criteria from storage, receiving the criteria from another entity, generating the criteria), (ii) comparing a quantity of the level of agreement to a corresponding threshold quantity of the criteria, and/or (iii) other methods. Determining whether the level of agreement meets the criteria may also include providing the level of agreement and the criteria to another entity responsible for comparing the level of agreement to the criteria.

If it is determined that the level of agreement meets the criteria, the method may proceed to operation 348. At operation 348, it may be concluded that the inference model does not provide the inconsistent responses to the first set of prompts (e.g., the inference model provides consistent responses to the first set of prompts). Concluding that the inference model does not provide the inconsistent responses to the first set of prompts may include: (i) generating a data structure indicating that the inference model does not provide the inconsistent responses to the first set of prompts, (ii) storing the data structure in a database and/or other storage architecture, (iii) notifying (e.g., via a message over a communication system, via a graphical user interface (GUI) on a device) another entity (e.g., the remote resource, the local resource, a downstream consumer) that the inference does not provide the inconsistent responses to the first set of prompts, and/or (iv) other methods.

The method may end following operation 348.

Returning to operation 346, the method may proceed to operation 350 if the level of agreement does not meet the criteria. At operation 350, it may be concluded that the inference model provides the inconsistent responses to the first set of prompts. Concluding that the inference model provides the inconsistent responses to the first set of prompts may include: (i) generating a data structure indicating that the inference model provides the inconsistent responses to the first set of prompts, (ii) storing the data structure in a database and/or other storage architecture, (iii) notifying (e.g., via a message over a communication system, via a GUI on a device) another entity (e.g., the remote resource, the local resource, a downstream consumer) that the inference model provides the inconsistent responses to the first set of prompts, and/or (iv) other methods.

The method may end following operation 350.

Thus, as illustrated above, embodiments disclosed herein may provide systems and methods usable to manage inference models to reduce an ability of an inference model to generate responses using an information content of poisoned training data and reduce a likelihood that the inference model generates responses using the information content of poisoned training data in the future. Following performance of two untraining procedures, the inference model may be evaluated (e.g., using a second, trusted inference model) to verify that the inference model does not generate responses using the information content of the poisoned training data and generates responses using an information content of known good training data. By doing so, a likelihood of providing computer-implemented services using the inference model as desired may be increased.

Any of the components illustrated in FIGS. 1-2F may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs, or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for providing computer-implemented services using inference models, the method comprising:
identifying that at least a portion of training data used to train an inference model is poisoned training data;
performing a first untraining procedure to reduce an ability of the inference model to generate responses using an information content of the poisoned training data;
performing a second untraining procedure to reduce a likelihood that the inference model generates the responses using the information content of the poisoned training data at a future point in time;
performing a first testing procedure to determine whether the inference model meets performance criteria, the performance criteria defining a level of ability of the inference model to provide desirable responses to at least a second set of prompts based on known good training data;
in a first instance of the performing in which the inference model meets the performance criteria:
concluding that the inference model is untrained on the poisoned training data and trained on the known good training data;
using the inference model to provide the computer-implemented services; and
in a second instance of the performing in which the inference model does not meet the performance criteria:
performing a retraining procedure to improve a likelihood that the inference model meets the performance criteria.

2. The method of claim 1, wherein performing the first untraining procedure comprises:
modifying weights of an architecture of the inference model until responses generated by the inference model are not based on the information content.

3. The method of claim 2, wherein performing the second untraining procedure comprises:
further modifying the weights of the architecture of the inference model so that the further modified weights are resistant to snap back to a state prior to the performing of the first untraining procedure.

4. The method of claim 1, wherein the poisoned training data comprises relationships established by a malicious entity.

5. The method of claim 1, wherein the inference model provides the desirable responses when the inference model provides inconsistent responses to a first set of prompts based on the poisoned training data and consistent and accurate responses to the second set of prompts based on the known good training data.

6. The method of claim 5, wherein the inference model providing the inconsistent responses to the first set of prompts indicates that the inference model is not trained on the poisoned training data, and the inference model providing the consistent and accurate responses to the second set of prompts indicates that the inference model is trained on the known good training data.

7. The method of claim 1, wherein performing the first testing procedure comprises:
performing a first attempting to verify that the inference model provides inconsistent responses to a first set of prompts based on the poisoned training data;
in a first instance of the first attempting where the inference model provides the inconsistent responses to the first set of prompts:
performing a second attempting to verify that the inference model provides consistent responses to the second set of prompts; and
in a first instance of the second attempting where the inference model provides the consistent responses to the second set of prompts:
performing a third attempting to verify that the inference model provides accurate responses to the second set of prompts.

8. The method of claim 7, wherein performing the first attempting comprises:
obtaining, using the first set of prompts, a set of responses from the inference model, the set of responses comprising:
a first response to a first prompt of the first set of prompts; and
a second response to a second prompt of the first set of prompts;
performing a response agreement testing process to obtain a level of agreement between at least the first response and the second response;
making a determination regarding whether the level of agreement meets criteria;
in a first instance of the determination in which the level of agreement meets the criteria:
concluding that the inference model does not provide the inconsistent responses to the first set of prompts; and
in a second instance of the determination in which the level of agreement does not meet the criteria:
concluding that the inference model provides the inconsistent responses to the first set of prompts.

9. The method of claim 7, wherein performing the third attempting comprises:
comparing a first information content of the consistent responses to the second set of prompts to a second information content of the known good training data to obtain a level of similarity between the first information content and the second information content;
making a determination regarding whether the level of similarity meets a level of similarity threshold;
in a first instance of the determination in which the level of similarity meets the level of similarity threshold:
concluding that the inference model provides the accurate responses to the second set of prompts; and
in a second instance of the determination in which the level of similarity does not meet the level of similarity threshold:
concluding that the inference model does not provide the accurate responses to the second set of prompts.

10. The method of claim 1, wherein the inference model is a generative artificial intelligence (AI) model.

11. A non-transitory machine-readable medium having instructions stored therein, which when executed by a processor, cause the processor to perform operations for providing computer-implemented services using inference models, the operations comprising:
identifying that at least a portion of training data used to train an inference model is poisoned training data;
performing a first untraining procedure to reduce an ability of the inference model to generate responses using an information content of the poisoned training data;
performing a second untraining procedure to reduce a likelihood that the inference model generates the responses using the information content of the poisoned training data at a future point in time;
performing a first testing procedure to determine whether the inference model meets performance criteria, the performance criteria defining a level of ability of the inference model to provide desirable responses to at least a second set of prompts based on known good training data;
in a first instance of the performing in which the inference model meets the performance criteria:
concluding that the inference model is untrained on the poisoned training data and trained on the known good training data;
using the inference model to provide the computer-implemented services; and
in a second instance of the performing in which the inference model does not meet the performance criteria:
performing a retraining procedure to improve a likelihood that the inference model meets the performance criteria.

12. The non-transitory machine-readable medium of claim 11, wherein performing the first untraining procedure comprises:
modifying weights of an architecture of the inference model until responses generated by the inference model are not based on the information content.

13. The non-transitory machine-readable medium of claim 12, wherein performing the second untraining procedure comprises:
further modifying the weights of the architecture of the inference model so that the further modified weights are resistant to snap back to a state prior to the performing of the first untraining procedure.

14. The non-transitory machine-readable medium of claim 11, wherein the poisoned training data comprises relationships established by a malicious entity.

15. The non-transitory machine-readable medium of claim 11, wherein the inference model provides the desirable responses when the inference model provides inconsistent responses to a first set of prompts based on the poisoned training data and consistent and accurate responses to the second set of prompts based on the known good training data.

16. A data processing system, comprising:
a processor; and
a memory coupled to the processor to store instructions, which when executed by the processor, cause the processor to perform operations for providing computer-implemented services using inference models, the operations comprising:
identifying that at least a portion of training data used to train an inference model is poisoned training data;
performing a first untraining procedure to reduce an ability of the inference model to generate responses using an information content of the poisoned training data;
performing a second untraining procedure to reduce a likelihood that the inference model generates the responses using the information content of the poisoned training data at a future point in time;
performing a first testing procedure to determine whether the inference model meets performance criteria, the performance criteria defining a level of ability of the inference model to provide desirable responses to at least a second set of prompts based on known good training data;
in a first instance of the performing in which the inference model meets the performance criteria:
concluding that the inference model is untrained on the poisoned training data and trained on the known good training data;
using the inference model to provide the computer-implemented services; and
in a second instance of the performing in which the inference model does not meet the performance criteria:
performing a retraining procedure to improve a likelihood that the inference model meets the performance criteria.

17. The data processing system of claim 16, wherein performing the first untraining procedure comprises:
modifying weights of an architecture of the inference model until responses generated by the inference model are not based on the information content.

18. The data processing system of claim 17, wherein performing the second untraining procedure comprises:
further modifying the weights of the architecture of the inference model so that the further modified weights are resistant to snap back to a state prior to the performing of the first untraining procedure.

19. The data processing system of claim 16, wherein the poisoned training data comprises relationships established by a malicious entity.

20. The data processing system of claim 16, wherein the inference model provides the desirable responses when the inference model provides inconsistent responses to a first set of prompts based on the poisoned training data and consistent and accurate responses to the second set of prompts based on the known good training data.
